(19) United States
(12) Patent Application Publication
(10) Pub. No.: US 2009/0271171 A1
(43) Pub. Date: Oct. 29, 2009

(54) EMULATOR DEVICE, AND A METHOD FOR TESTING A TEST TARGET DEVICE

(75) Inventors: Shotaro NAKAYAMA, Kawasaki (JP); Masanori NAGANUMA, Kawasaki (JP); Takashi SAWAKURI, Kawasaki (JP); Shigeki SEKINE, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/411,630

(22) Filed: Mar. 26, 2009

(30) Foreign Application Priority Data
Mar. 28, 2008 (JP) 2008-087566

(51) Int. Cl. G06F 9/455

(52) U.S. Cl. 703/23

(57) ABSTRACT

An emulator device is connected to a test target device provided with a communication protocol stack to be tested through a network. The emulator device operates a method including determining an operation to be executed with reference to a scenario that describes a series of operations to be executed in a sequence to be tested upon input of the scenario, sending a start notification, and executing the operation specified by the start notification by reading the operation from the scenario, so as to generate a packet to be sent to the test target device.

### CROSS-REFERENCE TO RELATED APPLICATIONS

This application is based upon and claims the benefit of priority of the prior Japanese Patent Application No. 2008-87566, filed on Mar. 28, 2008, the entire contents of which are incorporated herein by reference.

### FIELD

Various embodiments of the present invention relate to an emulator device to perform a test between computers mutually connected via a network.

### BACKGROUND

When a test on a developed communication protocol stack is performed, such as a TCP (Transmission Control Protocol) stack, the test is performed in a system illustrated in FIGS. 14A and 14B, for example. As illustrated in FIG. 14A, a test is performed on various sequences in a configuration in which a computer provided with a TCP stack to be tested and another computer provided with a tested TCP stack are mutually connected via a network.

A WAN (Wide Area Network) speed-up device or the like performs protocol conversion on TCP when performing communication between computers A and B. When such device is tested, the test is performed as illustrated in FIG. 14B is generally used. The system illustrated in FIG. 14B includes computers A and B provided with a tested TCP stack that are placed at both ends, and WAN speed-up devices to be tested are placed between computers A and B. With a system having such a configuration, TCP communication is performed between the ends, and a test is performed on the network system illustrated in FIGS. 14A and 14B.

In TCP, various operation sequences, such as a sequence of establishing synchronous connection, are defined by RFC (Request for Comment). An example of an operation sequence is illustrated in FIG. 15.

FIG. 15 is an operation sequence diagram of establishing synchronous connection. As illustrated in FIG. 15, in the sequence of establishing synchronous connection, each of two computers mutually connected via a network sends a connection request to the other side and waits for a connection request from the other side. After receiving the connection request from the other side, each of the computers waits for a response as acknowledgement of the sent connection request. After the acknowledgement has been received in each of the computers, connection is established and the sequence is completed.

In the sequence of establishing synchronous connection, the timing of sending a connection request to the other side is not based on the timing of receiving a packet from the other side, and thus it is difficult to determine the timing.

As a related art, a technique of analyzing details of communication is provided, by obtaining and analyzing a PDU (Protocol Data Unit) between communication systems in communication based on TCP/IP (Internet Protocol) and performing emulation while estimating an event sequence on the basis of content of the analysis (e.g., Patent Document 1: Japanese Unexamined Patent Application Publication No. 11-27308).

Also, regarding a technique of performing a test of TCP/IP, a technique of reproducing a trouble in TCP/IP is provided by processing traffic data in a pseudo communication environment established in a communication network emulator device (e.g., Patent Document 2: Japanese Unexamined Patent Application Publication No. 2004-201121).

Many operation sequences are defined in TCP. These operation sequences need to be tested by arbitrarily operating the sequences in the above-described test configuration so as to verify the operations. However, some of the operation sequences are difficult to be operated in the conventional system configuration.

An object of the present invention is to provide a technique of enabling verification of a normal operation of a protocol by generating various operation sequences in a test of a protocol stack.

### SUMMARY

A method for testing a test target device provided with a communication protocol stack to be tested includes determining an operation to be executed with reference to a scenario that describes a series of operations to be executed in a sequence to be tested upon input of the scenario, sending a start notification, and executing the operation specified by the start notification by reading the operation from the scenario, so as to generate a packet to be sent to the test target device.

An emulator device connected to a test target device provided with a communication protocol stack to be tested through a network includes a management unit configured to determine an operation to be executed with reference to a scenario describing a series of operations to be executed by the emulator device in a sequence to be tested upon input of the scenario, and send a start notification and an execution unit configured to execute the operation specified by the start notification received from the management unit by reading the operation from the scenario, thereby generating a packet to be sent to the test target device.

### BRIEF DESCRIPTION OF THE DRAWINGS

FIG. 1 is a functional block diagram of a computer including a TCP emulator according to an embodiment of the invention;

FIG. 2 is a flowchart illustrating an emulation process;

FIG. 3 illustrates an example of a scenario;

FIG. 4 illustrates a test of a sequence of establishing synchronous connection;

FIG. 5 illustrates a test method of a sequence of restoration from an old overlapped sequence;

FIG. 6 illustrates a test method of a sequence of synchronous close;

FIG. 7 illustrates a test method of a sequence of restoration from half open connection;

FIG. 8 is a flowchart illustrating a packet bypass process;

FIG. 9 is a flowchart illustrating a scenario step managing process

FIG. 10 is a flowchart illustrating a step executing process;

FIG. 11 is a flowchart illustrating the step executing process;

FIG. 12 illustrates a configuration of an information processing apparatus;

FIG. 13 illustrates a recording medium;

FIGS. 14A and 14B illustrate a system configuration to execute a test of a protocol stack; and

FIG. 15 is an operation sequence diagram of establishing synchronous connection.

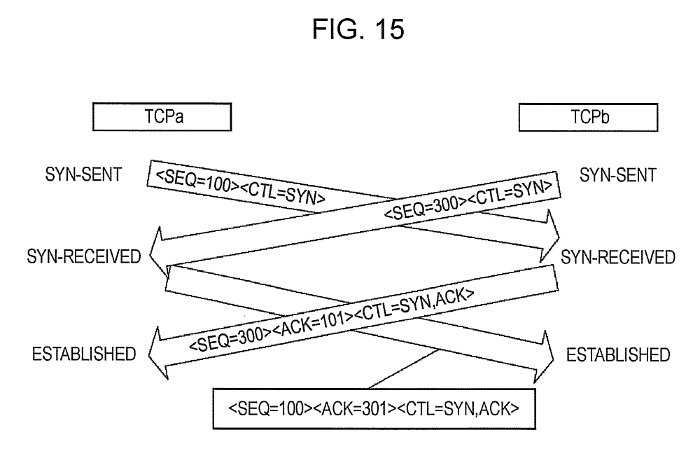

### DESCRIPTION OF EMBODIMENT

Hereinafter, an embodiment of the present invention is described with reference to the drawings.

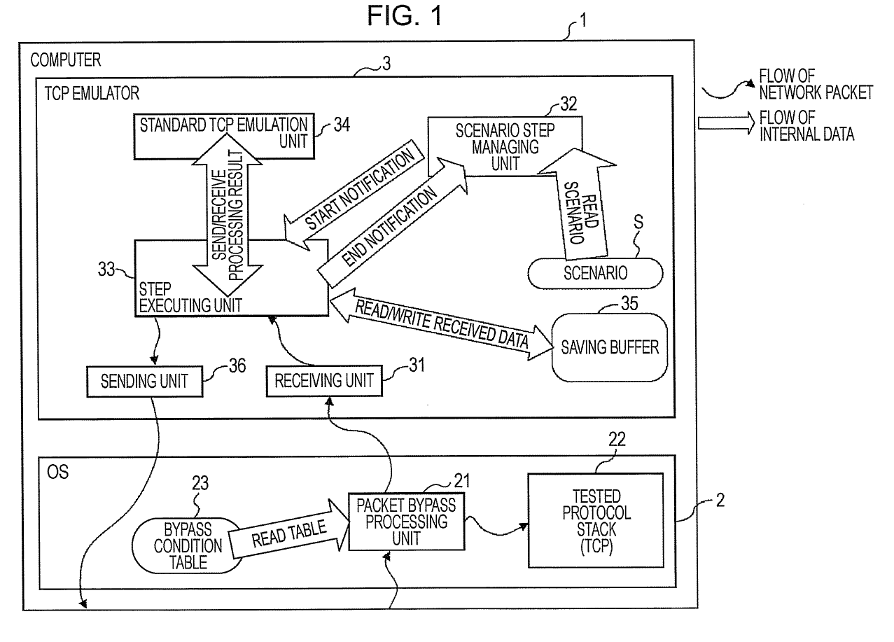

FIG. 1 is a functional block diagram of a computer including a TCP emulator according to an embodiment of the invention. The computer 1 illustrated in FIG. 1 is connected to another computer provided with a protocol stack to be tested via a network. The computer 1 includes an operation system (hereinafter referred to as “OS”) 2 and a TCP (Transmission Control Protocol) emulator (hereinafter referred to as “emulator”) 3.

The OS 2, to be operated in a processor, includes a packet bypass processing unit 21, a protocol stack unit 22, and a bypass condition table 23. The emulator 3 is a program to be processed by the processor to emulate a TCP operation, and is provided with a scenario including a series of operations defined by RFC (Request for Comment), and realizes respective operation sequences in a pseudo manner. The emulator 3 illustrated in FIG. 1 includes a receiving unit 31, a scenario step managing unit 32, a step executing unit 33, a standard TCP emulation unit 34, a sending unit 36, and a saving buffer 35.

The packet bypass processing unit 21 determines whether packets sent from another computer via a network should be supplied to the emulator 3 or should be processed in the OS 2, and sorts the packets based on the determination.

The protocol stack unit 22 includes a tested TCP stack and processes packets determined to be processed in the OS 2 by the packet bypass processing unit 21.

The bypass condition table 23 stores information indicating conditions to make a determination for sorting packets in the packet bypass processing unit 21.

The receiving unit 31 receives, from the OS 2, packets determined to be processed in the emulator 3 by the packet bypass processing unit 21 of the OS 2.

The scenario step managing unit 32 reads a scenario S of a test inputted to the computer 1 by a user, determines the operation that should be executed next, and allows the operation to be executed, thereby managing execution of the scenario.

“Scenario” is defined as description of operations to be executed in the own apparatus, that is, in the computer 1 including the emulator 2, when an operation sequence is executed between the computer 1 and another computer. The operations that are sequentially executed by the computer 1 in accordance with the scenario include an operation executed as a response to a packet received from the other computer, and an operation actively executed by the own apparatus to the other computer. Hereinafter, each of the operations executed in certain timing is called “step” in this embodiment.

The step executing unit 33 executes steps in accordance with instructions provided from the scenario step managing unit 32. The standard TCP emulation unit 34 sends/receives necessary information to/from the step executing unit 33 and emulates operations of the standard TCP.

The saving buffer 35 saves necessary data when the step executing unit 33 executes steps. Specifically, an entry of the saving buffer 35 includes an identifier and received data. The identifier includes identification information to identify each step described in the scenario and is added to the received data when the received data is saved to the saving buffer 35. When the data saved in the saving buffer 35 is to be restored, the saving buffer 35 is searched by using the identification information described in the scenario as a search key, so that the data that matches the identification information is extracted.

The sending unit 36 sends a packet that is obtained as a result of step execution in the step executing unit 33 and the standard TCP emulation unit 34 to the other computer.

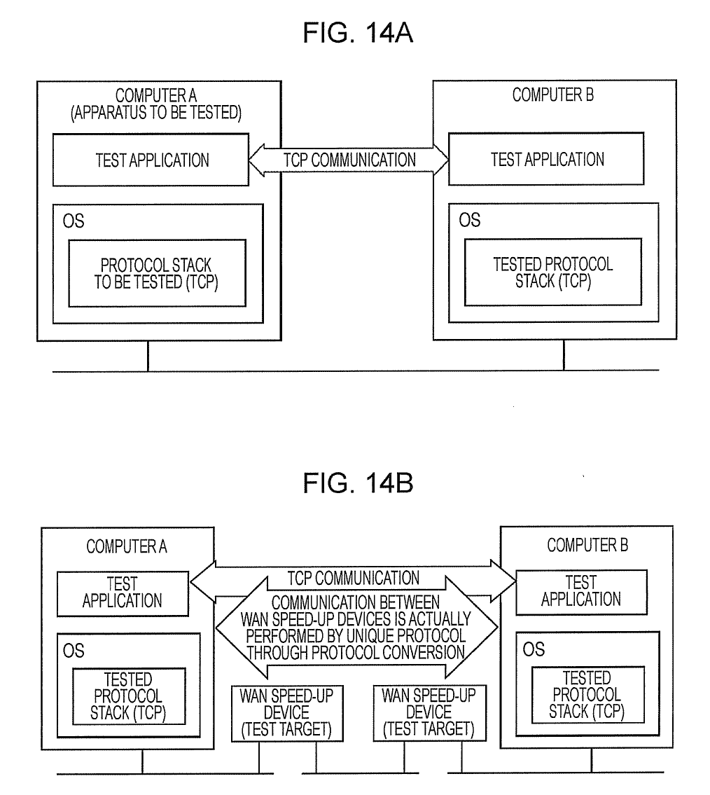

Incidentally, in the case where a test is performed on a WAN speed-up device and so on in the configuration illustrated in FIGS. 14A and 14B, a computer including the emulator 3 illustrated in FIG. 1 is applied to one or both of computers mutually connected via a network.

The determination made by the packet bypass processing unit 21 of the OS 2 is not essential. Alternatively, all packets received from the other computer may be supplied to the emulator 3.

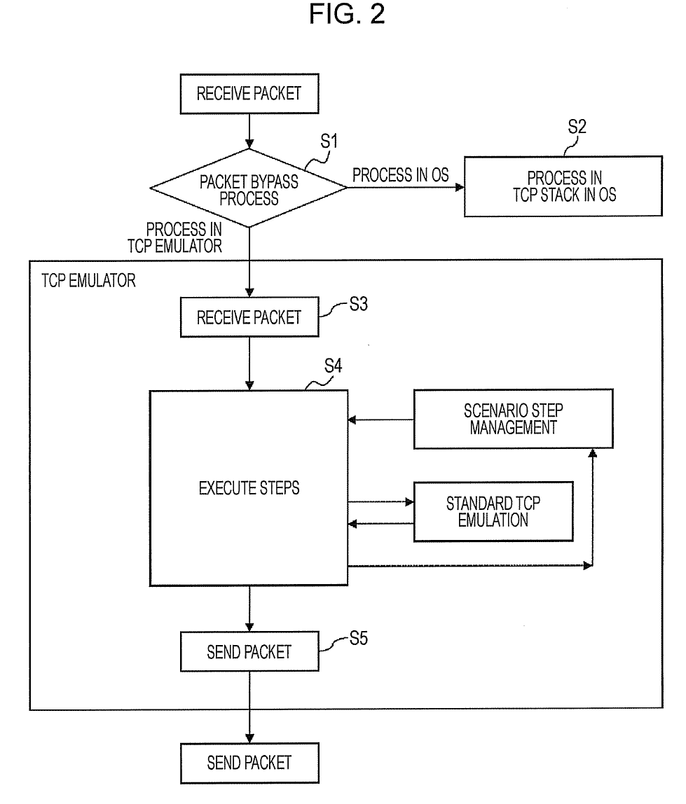

FIG. 2 is a flowchart illustrating a process operated by the computer 1. In the process illustrated in FIG. 2, S3 to S5 are performed by the emulator 3.

The process illustrated in FIG. 2 starts upon reception of a packet from the other computer through the network. In S1, the computer 1 performs a packet bypass process and determines whether the packet should be processed by the OS 2 or by the emulator 3. When the computer 1 determines that the packet should be processed by the OS 2, the process proceeds to S2, where the protocol stack unit 22 in the OS 2 processes the packet. When the computer 1 determines that the packet received in S1 should be processed by the emulator 3, the process proceeds to S3.

In S3, the receiving unit 31 of the emulator 3 receives the packet from the OS 2. In S4, certain steps are executed in accordance with a scenario.

The scenario step managing unit 32 notifies the step executing unit 33 of the step to be executed in the scenario in advance. The step executing unit 33 recognizes the step notified by the scenario step managing unit 32 in advance, and starts executing the specified step upon reception by the emulator 3 of the packet sent from the other computer. After the step has been executed, the step executing unit 33 notifies the scenario step managing unit 32 that the step has been executed. Upon receiving the end notification from the step executing unit 33, the scenario step managing unit 32 determines the step to be executed next and supplies the information thereof to the step executing unit 33.

As described above about the respective units illustrated in FIG. 1, the standard TCP emulation unit 34 is allowed to execute the process of standard TCP as necessary when the steps are executed.

After the steps have been executed, the process proceeds to S5. In S5, the emulator 3 sends the packet generated through execution of the steps to the other computer, and the process in FIG. 2 ends.

Execution of steps illustrated in FIG. 2 causes the packet to be sent from the computer 1 to the other computer. The packet sending process performed by the computer 1 includes a process of sending a response to a packet received from the other computer and a process of actively sending a packet from the computer 1 to the other computer. Which of those sending processes is applied to the packet sent in the process in FIG. 2 depends on description of the scenario. An example of the scenario is described hereinafter.

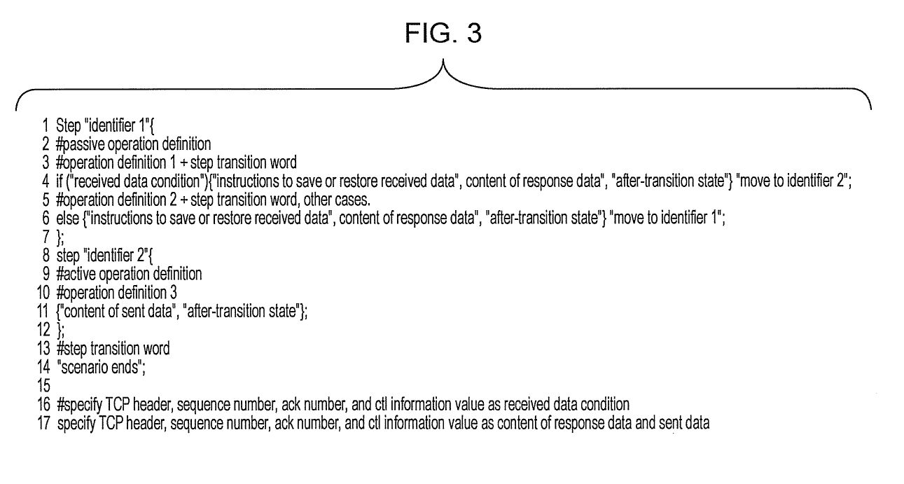

FIG. 3 illustrates an example of the scenario. In the scenario illustrated in FIG. 3, the sentences starting from symbol “#” (second, third, and . . . lines) are comment sentences. The emulator 3 sequentially reads the sentences in the lines without symbol “#” (first, fourth, sixth, and . . . lines) from the head of the scenario.

In the scenario, an operation is described in each step. One step includes an identifier, an operation definition, and a step transition word.

The identifier is identification information to uniquely identify a step. In the scenario example illustrated in FIG. 3, “identifier 1” and “identifier 2” described in the first and eighth lines correspond to identifiers.

The operation definition is a description about a single operation or a plurality of operations described in one step.

The operation definition is classified into an active operation definition and a passive operation definition. The active operation definition describes an operation to spontaneously send data from the computer 1 including the emulator 3 to the other computer. On the other computer, the passive operation definition describes an operation to respond to data received from the other computer.

The step transition word is a dedicated description prepared to indicate the operation definition of the step to be executed next after the operation definition of a certain step has been executed. In the scenario example illustrated in FIG. 3, “move to identifier 2” and “move to identifier 1” in the fourth and sixth lines correspond to step transition words.

The content of the operation definition is described in detail. In one step, any of the active operation definition and the passive operation definition is described.

The active operation definition describes the content of sent data and an after-transition TCP state. The after-transition TCP state indicates the TCP state of the protocol stack changed after execution of a process in accordance with the description of the operation definition and sending of a packet, and can be omitted. When the after-transition TCP state is omitted, the same behavior as that of the standard TCP is performed. In FIG. 3, the eleventh line corresponds to the active operation definition.

The passive operation definition describes a received data condition, instructions to save or restore received data, content of response data, and after-transition TCP state. In FIG. 3, the fourth and sixth lines correspond to the passive operation definition.

In this embodiment, the received data condition includes information set in a TCP segment in a packet received from the other computer. In the passive operation definition, a plurality of operation definitions can be described in one step. In the case where a plurality of passive operation definitions are described in one step, received data conditions different from each other need to be set.

Alternatively, the received data condition can be omitted. In the case in which description of the received data condition is omitted, a certain operation is selected for all pieces of received data.

The instructions to save or restore received data includes instructions to save data of a received packet to a certain area of the saving buffer 35 or restore data of the received packet from the certain area of the saving buffer 35.

The content of the response data includes data included in a packet sent to the other computer as a response in this embodiment.

The after-transition TCP state indicates the TCP state of the protocol stack changed after execution of a process in accordance with the description of the operation definition and sending of a packet, like the after-transition TCP state included in the active operation definition.

The content of the response data and the after-transition TCP state can be omitted.

Hereinafter, a description is given about a method for realizing a test of the sequence referred to in RFC793 by the emulator 3 according to this embodiment by using the scenario created in accordance with the above-described rule.

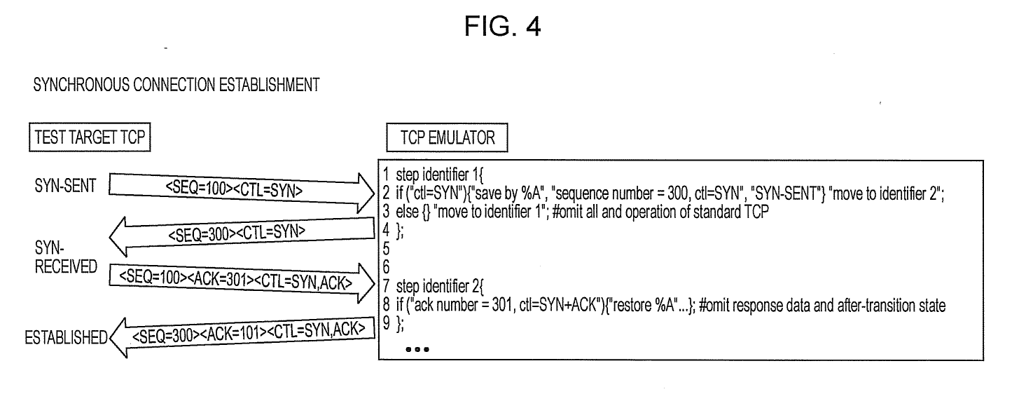

FIG. 4 illustrates a method for testing a sequence of establishing synchronous connection.

In order to test the sequence of establishing synchronous connection, the computer 1 receives a connection request from another computer, that is, another computer provided with the protocol stack to be tested, and then the emulator 3 sends a connection request to the other computer as described in first to fourth lines of the scenario in FIG. 4.

After receiving a response to the sent connection request from the other computer, the emulator 3 sends a response (ACK) to the connection request sent from the computer on the other side of the network, referred to as “the other computer” hereinafter, as described in seventh to ninth lines of the scenario in FIG. 4.

In this way, when the sequence of establishing synchronous connection is tested, the emulator 3 receives a connection request from the other computer, and then sends a connection request to the other computer before sending a response to the received connection request. A process of mutually sending connection requests between both computers and mutually sending responses to the connection requests from the other computer can be performed.

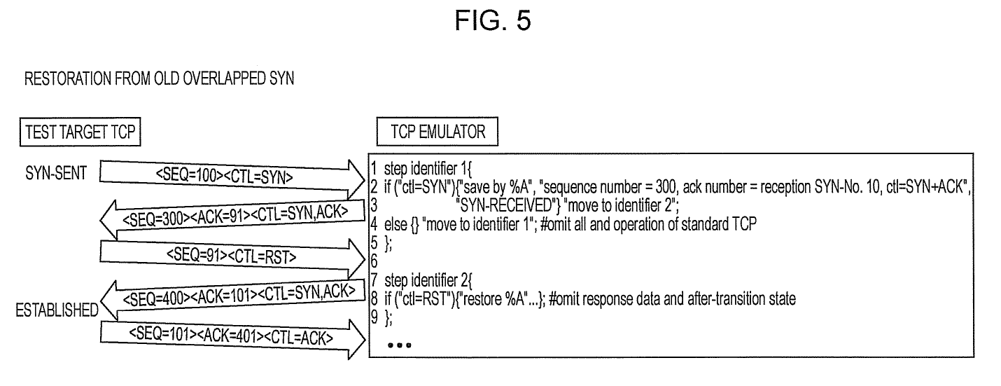

FIG. 5 illustrates a method for testing a sequence of a restoration process from an old overlapped sequence.

In order to reproduce a response to an old overlapped sequence number (SYN) in a pseudo manner, the emulator 3 saves a sequence number SEQ=100 received from the TCP of the computer to be tested, that is, the other computer, in the saving buffer 35, and sends SYN+ACK corresponding to an earlier sequence number. That is, the emulator 3 sends a response to a sequence number 100−10=90 older than the sequence number actually received as described in first to fifth lines of the scenario.

After receiving a request for resetting connection from the other computer, the emulator 3 restores the saved sequence number SEQ=100 and, sends the sequence number to the other computer as described in seventh to ninth lines of the scenario.

In this way, the other computer receives a response to the sequence number older than the actually-sent sequence number. Therefore, a test to determine whether a restoration process from an old sequence can be normally executed or not may be operated in the other computer, that is, in the computer provided with the protocol stack to be tested.

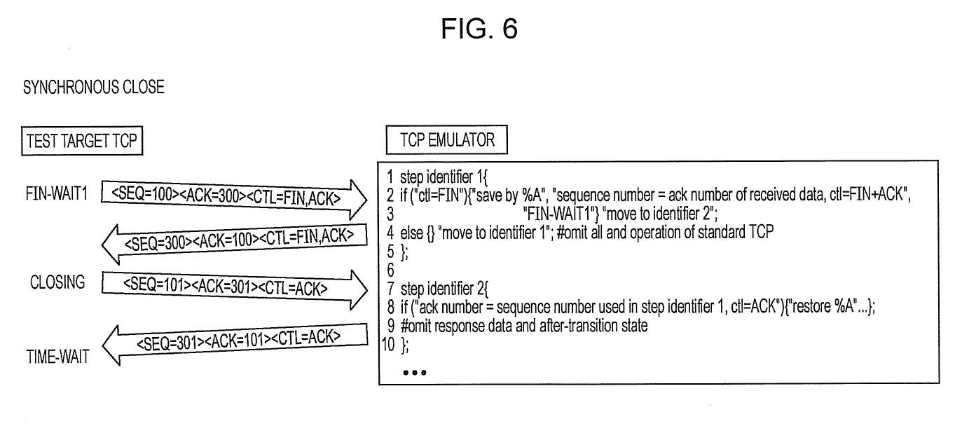

FIG. 6 illustrates a method for testing a sequence of synchronous close.

In order to emulate synchronous close, the emulator 3 receives “FIN” indicating no subsequent data from the computer provided with the protocol stack to be tested. The emulator 3 then saves the received “FIN” to the certain area of the saving buffer 35, and sends “FIN” to the other computer as described in first to fifth lines of the scenario.

After receiving a response to the sent “FIN”, the emulator 3 restores the saved “FIN” from the certain area of the saving buffer 35 and sends a response to the “FIN” received by the own apparatus to the other computer as described in seventh to tenth lines of the scenario.

In this way, the emulator 3 does not send a response immediately after receiving “FIN”, but sends “FIN” and then sends a response to the “FIN” that the computer 1 received after receiving a response from the other computer. Accordingly, the sequence of synchronous close can be tested.

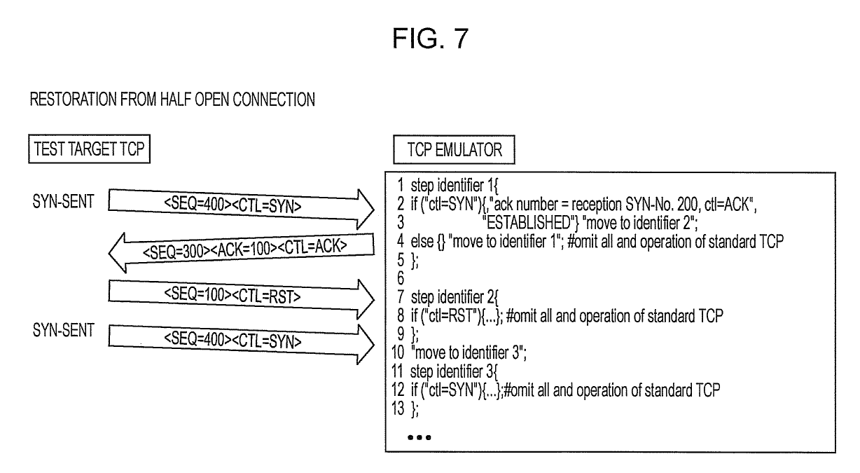

FIG. 7 illustrates a method for testing a sequence of restoration from half open connection.

In the test of the sequence of restoration from half open connection, it is assumed that the TCP of the other computer is crashed. The emulator 3 sends a response (ACK) of an old number to the connection request (sequence number SEQ=400) from the other computer in order to emulate the state in which connection is maintained, as described in first to fifth lines of the scenario.

The other computer that has received the response of the old number performs initialization of connection (CTL=RST), and then resends the connection request (sequence number SEQ=400).

In this way, the emulator 3 sends a response of a number earlier than the actually received sequence number of the connection request, so that restoration from half open connection can be realized.

As described above, the emulator 3 according to this embodiment determines the step to be executed among the steps described in the scenario, and executes certain operations in accordance with the content described in the step of the scenario. Accordingly, a test can be performed on a sequence that is difficult to be generated in a configuration of sending a response in accordance with a packet actually received from the other computer, such as the above-described sequence of establishing synchronous connection.

Hereinafter, a description is given about a specific processing method performed in the respective units of the computer 1 including the emulator 3 according to this embodiment.

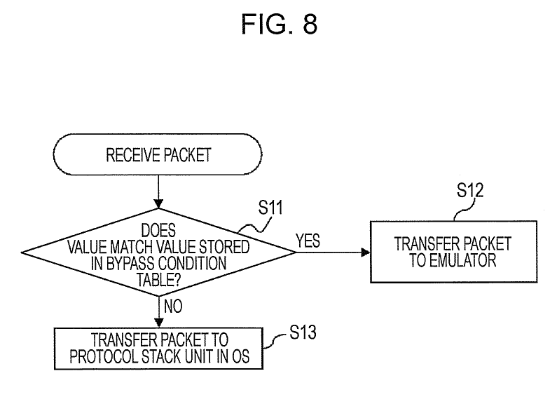

FIG. 8 is a flowchart illustrating a packet bypass process in the packet bypass processing unit 21 of the OS 2. The process illustrated in FIG. 8 starts upon recognition by the OS 2 of a packet sent from the other computer.

In S11, the packet bypass processing unit 21 refers to the bypass condition table 23 and determines whether the value set in a certain field of the received packet matches the value stored in the bypass condition table 23. The bypass condition table is described below.

If the packet bypass processing unit 21 determines in S11 that the value in the certain field of the received packet matches the value stored in the bypass condition table 23, the process proceeds to S12, where the packet bypass processing unit 21 transfers the packet to the emulator 3. Then, the process ends.

If the packet bypass processing unit 21 determines that the value in the certain field of the received packet does not match the value stored in the bypass condition table 23, the process proceeds to S13, where the packet bypass processing unit 21 transfers the packet to the protocol stack unit 22 of the OS 2. Then, the process ends.

The bypass condition table 23 that is referred to in S11 is referred to by the packet bypass processing unit 21. In this embodiment, an entry of the table includes four pieces of information: a destination IP (Internet Protocol) address, a transmission source IP address, a destination port number, and a transmission source port number.

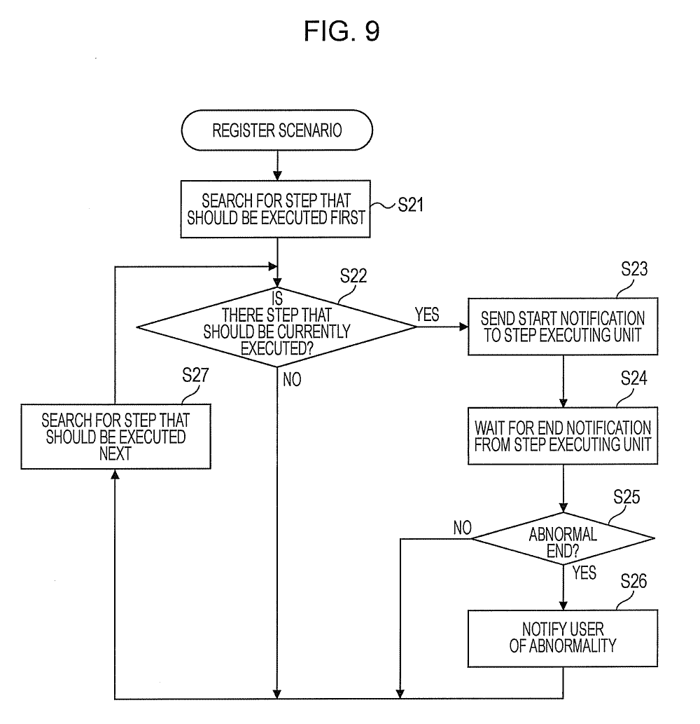

FIG. 9 is a flowchart illustrating a scenario step managing process performed by the scenario step managing unit 32 of the emulator 3. In this embodiment, this process starts upon registration of the scenario about the test to be started in the computer 1 by a user.

In S21, the scenario step managing unit 32 searches the registered scenario for the step that should be executed first. Then, in S22, the scenario step managing unit 32 determines whether there is a step that should be executed as a result or the search. The step that should be executed is a step that has not been executed among the steps described in the registered scenario and is a step describing an operation that should be executed next in the computer 1 at the timing of search.

If the scenario step managing unit 32 determines in S22 that there is no step that should be executed as a result of the search, no particular process is performed and the process proceeds to S27.

On the other hand, if the scenario step managing unit 32 determines in S22 that there is a step that should be executed, the process proceeds to S23, where the scenario step managing unit 32 sends a start notification to the step executing unit 33. Then, in S24, the scenario step managing unit 32 waits for an end notification from the step executing unit 33. After receiving the end notification, the process proceeds to S25, in which the scenario step managing unit 32 determines whether the execution of the step has normally ended.

If the scenario step managing unit 32 determines in S25 that the execution of the step has normally ended, the process proceeds to S27. On the other hand, if the scenario step managing unit 32 determines that the execution of the step has abnormally ended, the process proceeds to S26, where the scenario step managing unit 32 notifies the user of the abnormality. Then, the process proceeds to S27.

In S27, the scenario step managing unit 32 refers to the scenario and searches for the step that should be executed next, and the process returns to S22. Then, the same process is repeated until the process has been performed on all the steps described in the scenario.

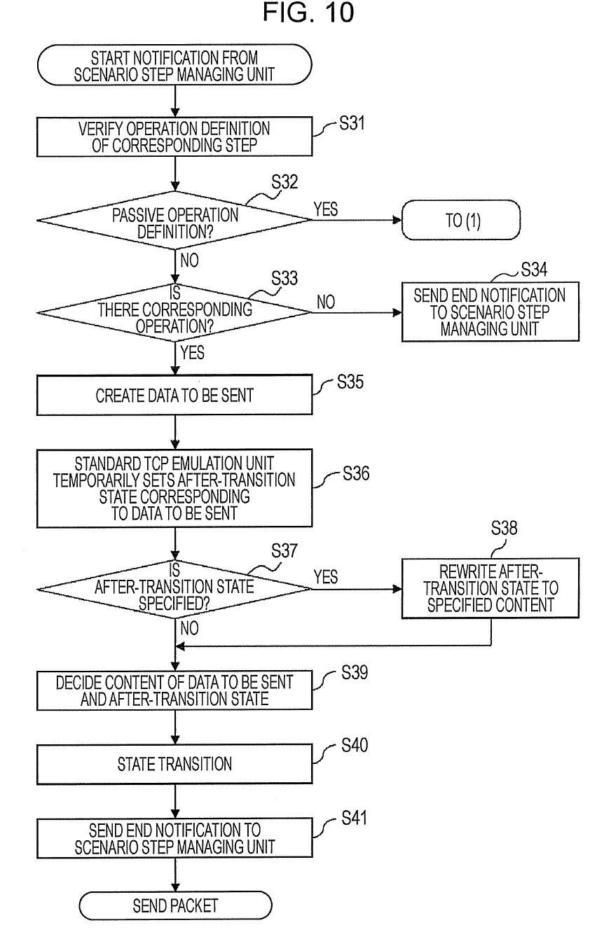

FIG. 10 is a flowchart illustrating a step executing process performed by the step executing unit 33. The process illustrated in FIG. 10 starts upon reception of a start notification from the scenario step managing unit 32.

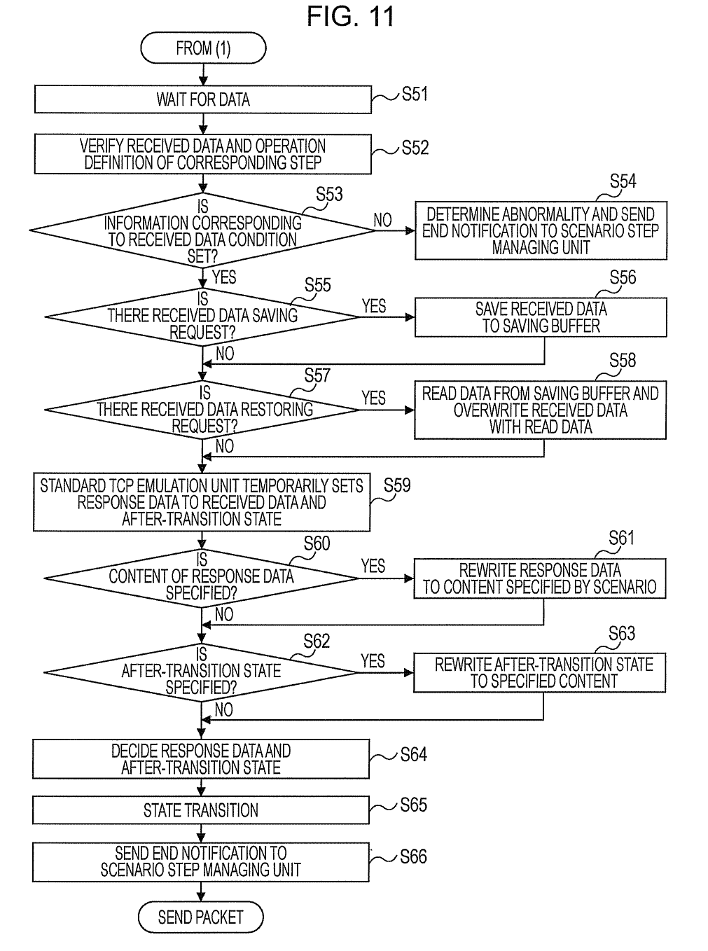

The step executing unit 33 verifies the operation definition of the step corresponding to the start notification received from the scenario step managing unit 32 in the scenario in S31, and determines whether the operation definition is a passive operation definition in S32. If the operation definition is a passive operation definition, the process proceeds to the process illustrated in FIG. 11, which is described in detail below. If the operation definition is not a passive operation definition, the process proceeds to S33.

In S33, the step executing unit 33 determines the presence/absence of an operation described about the step corresponding to the received start notification in the scenario. If there is no corresponding operation described, the process proceeds to S34, where the step executing unit 33 sends an end notification to the scenario step managing unit 32. Then, the process ends. If there is a corresponding operation described, the process proceeds to S35, where the step executing unit 33 creates data to be sent to the other computer in accordance with the description of the scenario.

In S36, the step executing unit 33 and the standard TCP emulation unit 34 send/receive their processing results to/from each other, and the standard TCP emulation unit 34 temporarily sets an after-transition TCP state corresponding to the data to be sent. Then, in S37, the step executing unit 33 refers to the description of the scenario and determines whether the after-transition TCP state is specified.

If the step executing unit 33 determines in S37 that the after-transition TCP state is specified by the scenario, the process proceeds to S38, where the step executing unit 33 rewrites the after-transition TCP state to the specified content. Then, the process proceeds to S39. If the step executing unit 33 determines in S37 that the after-transition TCP state is not specified by the scenario, the process proceeds to S39 with no particular process.

In S39, the step executing unit 33 decides the content of the data to be sent and the after-transition TCP state. In S40, the step executing unit 33 allows transition of the TCP state to the state decided in S39. Finally, the step executing unit 33 sends an end notification to the scenario step managing unit 32 in S41, and then sends the packet to the other computer. Then, the process ends.

FIG. 11 is a flowchart illustrating the step executing process performed by the step executing unit 33. The process illustrated in FIG. 11 is performed when the operation definition of the scenario is a passive operation definition.

In S51, the step executing unit 33 waits for data sent from the other computer. After the step executing unit 333 receives the data, the process proceeds to S52, where the step executing unit 33 verifies the received data and the operation definition of the step corresponding to the start notification received from the scenario step managing unit 32.

In S53, the step executing unit 33 determines whether the information corresponding to the received data condition described in the operation definition is set in the received data. If the step executing unit 33 determines that the information corresponding to the received data condition is not set in the received data, the process proceeds to S54, where the step executing unit 33 sends an end notification to the scenario step managing unit 32 and also notifies the scenario step managing unit 32 of an abnormal operation.

If the step executing unit 33 determines in S53 that the information corresponding to the received data condition is set in the received data, the process proceeds to S55, where the step executing unit 33 further determines whether the operation definition includes a description of saving the received data.

If the step executing unit 33 determines in S55 that there is a received data saving request, the process proceeds to S56, where the step executing unit 33 saves the received data to the saving buffer 35, and the process proceeds to S57. If the step executing unit 33 determines in S55 that there is no received data saving request, the process proceeds to S57 with no particular process. In S57, the step executing unit 33 determines whether or not the operation definition includes a description of restoring the received data.

If the step executing unit 33 determines in S57 that there is a received data restoring request, the process proceeds to S58, where the step executing unit 33 reads the corresponding data from the saving buffer 35 and overwrites the received data with the read data. Then, the process proceeds to S59. If the step executing unit 33 determines in S57 that there is no received data restoring request, the process proceeds to S59 with no particular process.

In S59, the step executing unit 33 and the standard TCP emulation unit 34 send/receive their processing results to/from each other, and the standard TCP emulation unit 34 temporarily sets response data to the received data and an after-transition TCP state.

In S60, the step executing unit 33 determines whether or not the content of the response data to be sent to the computer on the other computer is described in the operation definition of the scenario. If the content of the response data is specified by the scenario, the process proceeds to S61, where the step executing unit 33 rewrites the response data to the content specified by the scenario. Then, the process proceeds to S62. If the content of the response data is not specified by the scenario, the process proceeds to S62 with no particular process.

In S62, the step executing unit 33 determines whether or not the after-transition TCP state is specified by the scenario. If the after-transition TCP state is specified, the process proceeds to S63, where the step executing unit 33 rewrites the after-transition TCP state to the content specified by the scenario. Then, the process proceeds to S64. If the after-transition TCP state is not described in the scenario, the process proceeds to S64 with no particular process.

In S64, the step executing unit 33 decides the content of the response data and the after-transition TCP state. In S65, transition of the TCP state is performed on the basis of the TCP state decided in S64. Finally, the step executing unit 33 sends an end notification to the scenario step managing unit 32 in S66, and then sends the packet to the other computer. Then, the process ends.

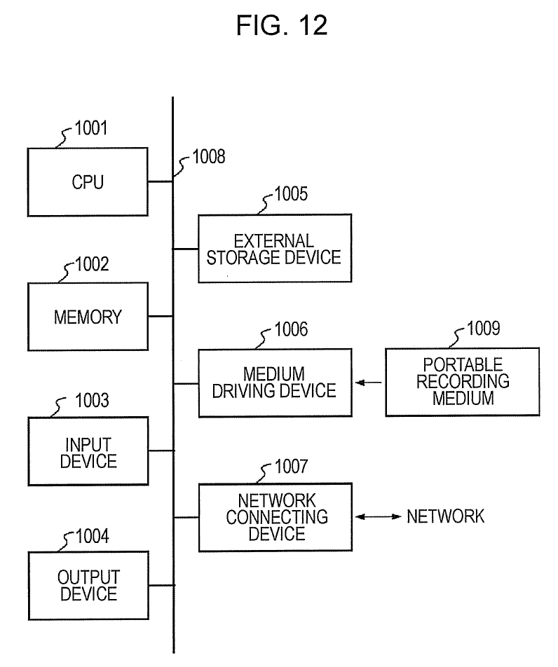

Incidentally, the emulator 3 illustrated in FIG. 1 may be constituted by using the computer illustrated in FIG. 12, for example. The information processing apparatus illustrated in FIG. 12 includes a CPU 1001, a memory 1002, an input device 1003, an output device 1004, an external storage device 1005, a medium driving device 1006, and a network connecting device 1007, which are mutually connected via a bus 1008.

The memory 1002 includes a ROM (read only memory) and a RAM (random access memory), for example, and stores a program and data used in the processes. The CPU 1001 executes the program by using the memory 1002 so as to perform necessary processes.

The saving buffer 35 illustrated in FIG. 1 corresponds to the memory 1002. Also, the receiving unit 31, the scenario step managing unit 32, the step executing unit 33, the standard TCP emulation unit 34, and the sending unit 36 illustrated in FIG. 1 correspond to the functions realized by execution of the program stored in the memory 1002.

The input device 1003 includes a keyboard, a pointing device, a touch panel, and so on, and is used to input instructions from a user and information. The output device 1004 includes a display, a printer, a speaker, and so on, and is used to output an inquiry to the user, alarm, and processing results.

The external storage device 1005 includes a magnetic disk device, an optical disc device, a magneto-optical disc device, a tape device, or the like. In the information processing apparatus, the above-described program and data are stored in the external storage device 1005 and are used as necessary by being loaded to the memory 1002.

The medium driving device 1006 drives a portable recording medium 1009 and accesses the data recorded thereon. The portable recording medium 1009 is an arbitrary computer-readable recording medium, such as a memory card, a flexible disk, a CD-ROM (compact disc read only memory), an optical disc, or a magneto-optical disc. A user stores the above-described program and data on the portable recording medium 1009 and uses them as necessary by loading them to the memory 1002.

The network connecting device 1007 connects to an arbitrary communication network, such as a LAN (local area network) or the Internet and performs data conversion involved in communication. The information processing apparatus receives the above-described program and data from an external apparatus via the network connecting device 1007 as necessary and uses them by loading them to the memory 1002.

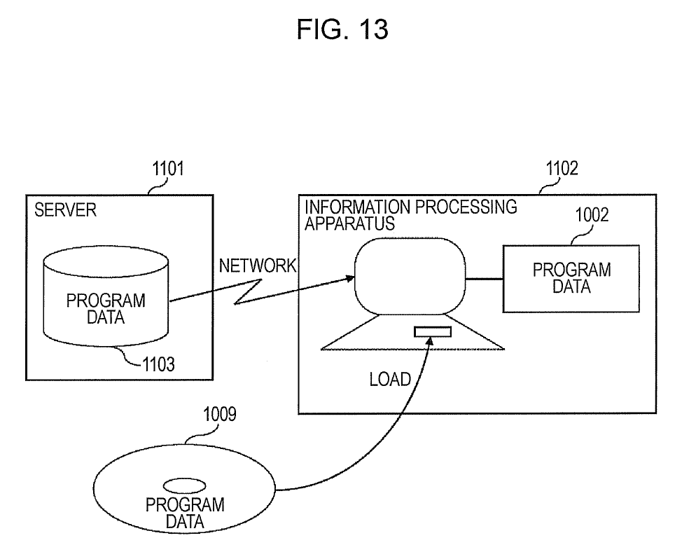

FIG. 13 illustrates a computer-readable recording medium capable of supplying the program and data to the information processing apparatus illustrated in FIG. 12. The program and data stored in the portable recording medium 1009 or a database 1103 in a server 1101 are loaded to the memory 1002 of an information processing apparatus 1102. The server 1101 generates a carrier signal to carry the program and data and sends the signal to the information processing apparatus 1102 via an arbitrary transmission medium on the network. The CPU 1001 executes the program by using the data and performs necessary processes.

As described above, according to the emulator 3 of this embodiment, a packet to be sent to a computer on the other side of the network is generated in accordance with the description of an input scenario and is sent, so that various operation sequences in TCP communication can be realized. In a network system including a TCP stack of a computer and a WAN sped-up device or the like to perform protocol conversion on TCP, the emulator is effective for execution of a test to verify normality of a TCP operation under various situations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An emulator device connected to a test target device provided with a communication protocol stack to be tested through a network, the emulator device comprising:
managing means for determining an operation to be executed with reference to a scenario describing a series of operations to be executed by the emulator device in a sequence to be tested upon input of the scenario, and sending a start notification; and
executing means for executing the operation specified by the start notification received from the managing means by reading the operation from the scenario, thereby generating a packet to be sent to the test target device.

2. The emulator device according to claim 1,
wherein the scenario describes identification information to identify an operation and next-operation identification information including identification information of an operation to be executed next in units of operations, the identification information being associated with the next-operation identification information, and
the managing means reads the next-operation identification information associated with the operation and sends a start notification of the operation indicated by the next-operation identification information to the executing means at a time when the scenario is input or at a time when an end notification of the operation is received from the executing means.

3. The emulator device according to claim 2,
wherein, in the scenario, each of the operations has at least one of a passive operation describing a response operation to a packet received from the test target device and an active operation describing an operation of spontaneously sending a packet from the emulator device,
wherein the passive operation and the active operation include an after-transition protocol state after the operation has been executed in the emulator device, and
wherein the executing means executes the operation specified by the start notification received from the managing means and then changes a protocol state to the after-transition protocol state of the operation.

4. The emulator device according to claim 3,
wherein the passive operation includes one or more operations, and a condition decided on the basis of content of the packet received from the test target device is defined in each of the operations, and
wherein, if the operation specified by the start notification received from the managing means is the passive operation, the executing means executes the operation in which the condition corresponding to the content of the packet received from the test target device is set.

5. The emulator device according to claim 3,
wherein the active operation further includes information about content of the packet to be sent, and
wherein, if the operation specified by the start notification received from the managing means is the active operation, the executing means generates the packet to be sent with reference to the information about the content of the packet to be sent described in the operation.

6. The emulator device according to claim 2, further comprising:
emulation means for emulating a standard operation of the communication protocol and sending a result to the executing means when being provided with instructions from the executing means,
wherein, when the executing means receives instructions about an operation to be executed from the managing means, the executing means refers to the description of the operation in the scenario, and provides instructions to perform emulation to the emulation means if the scenario describes that the standard operation of the communication protocol is to be emulated.

7. The emulator device according to claim 1, further comprising:
determining means for determining whether the packet should be executed in the executing means based on the content of the packet received from the test target device.

8. A method for testing a test target device provided with a communication protocol stack to be tested, the method comprising:
determining an operation to be executed with reference to a scenario that describes a series of operations to be executed in a sequence to be tested upon input of the scenario;
sending a start notification; and
executing the operation specified by the start notification by reading the operation from the scenario, thereby generating a packet to be sent to the test target device.

9. An emulator device connected to a test target device provided with a communication protocol stack to be tested through a network, the emulator device comprising:
a management unit configured to determine an operation to be executed with reference to a scenario describing a series of operations to be executed by the emulator device in a sequence to be tested upon input of the scenario, and send a start notification; and
an execution unit configured to execute the operation specified by the start notification received from the management unit by reading the operation from the scenario, thereby generating a packet to be sent to the test target device.
